(19) United States
(12) Patent Application Publication
(10) Pub. No.: US 2025/0074541 A1
(43) Pub. Date: Mar. 6, 2025

(54) BIKE PEDAL STUD AND METHOD OF USE THEREOF

(71) Applicant: Luke Simmons, Malabar (AU)

(72) Inventor: Luke Simmons, Malabar (AU)

(21) Appl. No.: 18/816,104

(22) Filed: Aug. 27, 2024

(30) Foreign Application Priority Data
Aug. 28, 2023 (AU) 2023902770

(51) Int. Cl. B62M 3/08

(52) U.S. Cl. CPC B62M 3/086

(57) ABSTRACT

A bike pedal stud, comprising: a member, wherein: the member comprises a cylindrical hole centrally positioned within the member and extending at least partially through the member; the member is press fit onto a pin of a bike pedal whereby the pin is inserted within the cylindrical hole of the member; a diameter of the cylindrical hole is smaller than a diameter of the pin such that the member remains positioned on the pin due to a friction fit between the member and the pin; and the member at least partially covers the pin when press fit onto the pin such that any contact between a skin of a user and the pin is prevented.

### FIELD OF THE DISCLOSURE

This disclosure relates to bike pedals in general, and more particularly, to bike pedal studs.

### BACKGROUND

Bike pedal studs are used for providing grip between a sole of a shoe of a user riding a bike and a bike pedal of the bike during riding. Traditionally, bike pedal studs include cylindrical threaded metal pins that are attached to the bike pedal by screwing the cylindrical threaded metal pins into corresponding threaded through-holes in the bike pedal. Traditional bike pedal studs continue to pose a safety risk as the metal pins can cause injury when accidental contact between skin of the user and the metal pins occurs during riding. Further, traditional bike pedal studs are not easily interchangeable during riding and do not accommodate for different grip strengths between the sole of the shoe of the user and the bike pedal.

Accordingly, a bike pedal stud that prevents injury to riders and is easily attached and detached from a bike pedal is needed.

### SUMMARY

Aspects of the invention provide a bike pedal stud, comprising: a member, wherein: the member comprises a cylindrical hole centrally positioned within the member and extending at least partially through the member; the member is press fit onto a pin of a bike pedal whereby the pin is inserted within the cylindrical hole of the member; a diameter of the cylindrical hole is smaller than a diameter of the pin such that the member remains positioned on the pin due to a friction fit between the member and the pin; and the member at least partially covers the pin when press fit onto the pin such that any contact between a skin of a user and the pin is prevented.

Aspects of the invention provide a bike pedal comprising: a pedal; a plurality of pins; and a plurality of the bike pedal studs described above.

Aspects of the invention include a method for providing grip between a shoe of a user riding a bike and a bike pedal of the bike during riding, comprising: attaching a plurality of the bike pedal stud described above to a plurality of corresponding pins mounted onto the bike pedal.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1-7 illustrate an example of a bike pedal stud and components thereof.

FIGS. 8A and 8B illustrate an example of a bike pedal and a plurality of bike pedal studs.

FIGS. 9A and 9B illustrate examples of different insert covers.

FIGS. 10A and 10B illustrate an example of a bike pedal stud.

FIGS. 10C-10F illustrate a bike pedal and one or more of the bike pedal stud illustrated in FIGS. 10A and 10B.

FIGS. 11A and 11B illustrate an example of a bike pedal stud.

FIGS. 11C and 11D illustrate a bike pedal and one or more of the bike pedal stud illustrated in FIGS. 11A and 10B.

### DETAILED DESCRIPTION OF SOME EMBODIMENTS

The present inventions will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well known process steps and/or structures have not been described in detail in order to not unnecessarily obscure the present invention. Further, it should be emphasized that several inventive techniques are described, and embodiments are not limited to implanting all of those techniques, as various cost and engineering trade-offs may warrant embodiments that only afford a subset of the benefits described herein or that will be apparent to one of ordinary skill in the art.

In the following detailed description of exemplary embodiments of the invention, reference is made to accompanying drawings (where like numbers represent like elements), which form a part hereof, and in which is shown by way of illustration specific exemplary embodiments in which the invention may be practiced. These embodiments are described in sufficient detail to enable those skilled in art to practice the invention, but other embodiments may be utilized, and logical, mechanical, and other changes may be made without departing from the scope of the present invention. The following detailed description is, therefore, not to be taken in a limiting sense.

Aspects of the invention provide a bike pedal stud. A plurality of the bike pedal studs are directly or indirectly attached to a bike pedal of a bike for the purpose of providing grip between a sole of a shoe of a user and the bike pedal during riding. The bike pedal stud also functions to prevent injuries caused due to accidental contact between skin of the user and traditional metal studs of a bike pedal.

In some embodiments, the bike pedal stud comprises an insert component and an insert cover. In such embodiments, the insert component directly or indirectly attaches to a bike pedal. In some embodiments, the insert component comprises a centered, cylindrical through-hole. In some embodiments, an internal surface of the insert component defining the cylindrical through-hole is threaded. The insert component may be attached to a threaded pin fixed to or mounted onto the bike pedal. Different methods may be used to attach the insert component to the bike pedal. For instance, a shape and/or texture of the internal surface of the insert component and the pin may be modified to facilitate attachment of the insert component to the pin fixed to or mounted onto the bike pedal. In some embodiments, the insert component is fabricated of metal (as opposed to a softer material, such as a polymer) to prevent the threads of the insert component from being stripped as the insert component is tightened onto the threaded pin of the bike pedal. In some cases, however, the insert component may be fabricated from other materials.

In some embodiments, at least a top portion of the insert component is covered by the insert cover. In some embodiments, the insert cover is molded onto at least the top portion of the insert component. In some embodiments, the insert cover is fixed or attached to or mounted onto the insert component using other means. For example, the insert component and the insert cover may be threaded or press fit together or an adhesive may be used to fix the insert component and the insert cover to one another. In some embodiments, at least a portion of an outer surface (e.g., a curved outer surface) of the top portion of the insert component is undulating. In some embodiments, the insert cover is fabricated of polymer. The material from which the insert cover is fabricated may vary in different embodiments. For instance, examples of materials that may be used to fabricate the insert cover include various polymers and elastomers, such as thermoplastic polyurethane (TPU).

A height, radius or width, and a sharpness of a top point of the bike pedal stud may vary in embodiments, depending on the materials from which the bike pedal stud is fabricated. Different bike riders may desire different heights, radii or widths, and sharpness of the top point of the bike pedal stud to achieve different levels of grip between a sole of their shoe and their bike pedal.

In some embodiments, a bottom portion of the insert component is exposed. In some embodiments, the bottom portion of the insert component is hexagonal such that a wrench may be used to attach or detach the bike pedal stud from the pin of the bike pedal. For instance, a user may use a wrench to detach a damaged bike pedal stud from a pin mounted onto their bike pedal during riding and replace it with another bike pedal stud using the wrench. In some embodiments, the entire insert component may be covered by the insert cover.

In some embodiments, the insert component comprises a threaded pin. In such a case, the bike pedal stud may be attached to the bike pedal by screwing the threaded pin into a threaded hole of the bike pedal.

In some embodiments, the insert component is omitted and the insert cover is directly fixed or attached to or mounted onto the pin of the bike pedal or the bike pedal. For instance, in some embodiments, the bike pedal stud comprises a cylindrical member. This may be a case wherein the insert component is omitted and the insert cover (i.e., the cylindrical member) is directly fixed or attached to or mounted onto the pin of the bike pedal. In some embodiments, the cylindrical member comprises a cylindrical through-hole concentrically positioned within the cylindrical member. In some embodiments, the cylindrical member comprises a cylindrical hole concentrically positioned within the cylindrical member, extending only partially through the cylindrical member. The method of fixing or attaching or mounting the cylindrical member to the pin of the bike pedal may vary in different embodiments. For example, the cylindrical member may be fixed or attached to or mounted onto the pin of the bike pedal by a user manually press fitting the cylindrical member onto the pin. The cylindrical member may be stretched over the pin of the bike pedal to secure the cylindrical member in place. The cylindrical member covers the pin, thereby protecting legs of the user from potential laceration caused by contact with the pin. A diameter of the cylindrical through-hole is slightly smaller than a diameter of the pin of the bike pedal, such that the cylindrical member remains in place due to a friction or interference fit between the cylindrical member and the pin.

In some embodiments, at least one of a top surface and a bottom surface of the cylindrical member comprises a concentrically positioned recessed annular feature. In some embodiments, the top surface and the bottom surface of the cylindrical member comprise a concentrically positioned recessed annular feature to prevent users from accidentally mounting the cylindrical member onto the pin of the bike pedal the wrong way. In such embodiments, the cylindrical member may be mounted onto the pin by inserting the pin into the through-hole via the top surface or the bottom surface of the cylindrical member. In embodiments wherein a collar is disposed at a base of the pin of the bike pedal, such that a bottom surface of the collar interfaces with a surface of the bike pedal from which the pin extends, the collar fits within the recessed annular feature. In such embodiments, the top surface or the bottom surface of the cylindrical member interfaces with the surface of the bike pedal from which the pin extends. The recessed annular feature also provides a diversion for water (e.g., when riding during rainy conditions), preventing water from collecting on the top surface or the bottom surface of the cylindrical member, whereby friction between the sole of the shoe and the cylindrical member may be compromised. Further, the recessed annular feature reduces contact surface area between the sole of the shoe and the top surface or the bottom surface of the cylindrical member, thereby increasing pressure per unit area, driving the cylindrical member slightly further into the sole of the shoe for a better grip. With the recessed annular feature, the top surface and/or the bottom surface of the cylindrical member is also annular, having both an outer edge and an inner edge defining the annular top surface and/or the annular bottom surface. The two edges generate more friction against the sole of the shoe. Although without the recessed annular feature, the top surface and/or the bottom surface of the cylindrical member has one edge defining the perimeter and an edge defining the through-hole, the edge defining the through-hole does not contribute to friction as the sole of the shoe deforms in a dome shape and fails to contact the edge defining the through-hole. The recessed annular feature provides another edge with a larger diameter that the sole of the shoe can drag against when needed.

A shape of the recessed feature may be different in different embodiments. For example, at least one of the top surface and the bottom surface of the cylindrical member may comprise a centrally positioned recessed rectangular feature. An outer diameter of the cylindrical member may vary in different embodiments, wherein a larger outer diameter is suitable for shoes with softer soles (e.g., running shoes) and a smaller outer diameter is suitable for shoes with harder soles (e.g., mountain biking shoes). A larger outer diameter provides a larger contact surface area, and thereby less aggressive contact, between the cylindrical member and the skin of the user. A greater contact surface area between the cylindrical member and the skin of the user reduces the amount of pressure per unit area applied on the skin upon impact.

In some embodiments, the cylindrical member is of another shape. For example, the bike pedal stud may comprise a rectangularly-shaped member comprising the cylindrical through-hole centrally positioned within the rectangularly-shaped member. In different embodiments, a type of the pin may vary (e.g., cylindrical threaded pin, cylindrical smooth pin, star-shaped pin, etc.). The type of pin may be particularly selected for optimal friction fit or attachment between the bike pedal stud and the pin of the bike pedal. The interior surface of the cylindrical member defining the cylindrical through-hole may be modified in different embodiments for optimal friction fit or attachment between the bike pedal stud and the pin of the bike pedal. For example, the interior surface of the cylindrical member defining the cylindrical through-hole may be textured to enhance friction, and subsequently strength of attachment, between the bike pedal stud and the pin of the bike pedal. In another example, the interior surface of the cylindrical member defining the cylindrical through-hole may be threaded and the type of pin may be a cylindrical threaded pin such that the cylindrical member may be threaded onto the threaded pin of the bike pedal, enhancing the strength of attachment between the bike pedal stud and the pin.

In some embodiments, the cylindrical member is fabricated of a polymer, such as TPU. The TPU may have a shore hardness ranging between 90A-100A. In some embodiments, the TPU has a shore hardness of 95A. With optimal hardness, the cylindrical member is firm enough to press into the sole of the shoe, similar to the pin of the bike pedal, but has enough flex to not pierce the skin of the user upon contact.

Aspects of the invention provide a bike pedal comprising at least a pedal and a plurality of bike pedal studs. In some embodiments, the plurality of bike pedal studs are directly attached or mounted to the bike pedal. In some embodiments, the plurality of bike pedal studs are attached or mounted to a plurality of corresponding pins attached or mounted to the bike pedal.

Aspects of the invention include a method for providing grip between a shoe of a user riding a bike and a bike pedal of the bike during riding. In embodiments, the method includes attaching a plurality of bike pedal studs to a plurality of corresponding pins attached or mounted to the bike pedal.

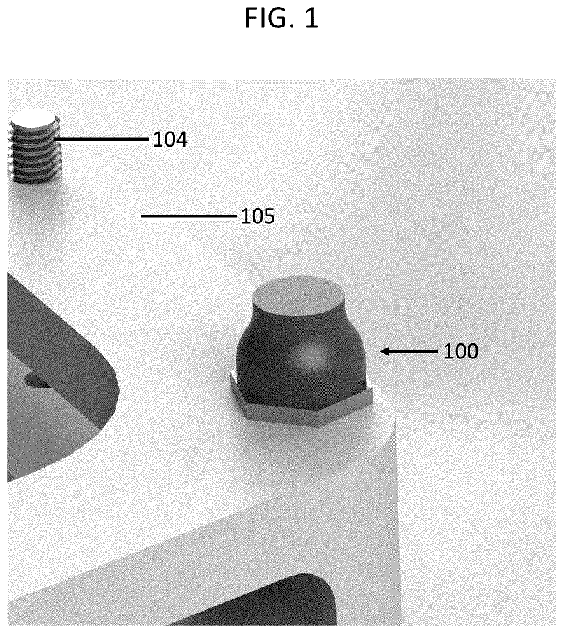

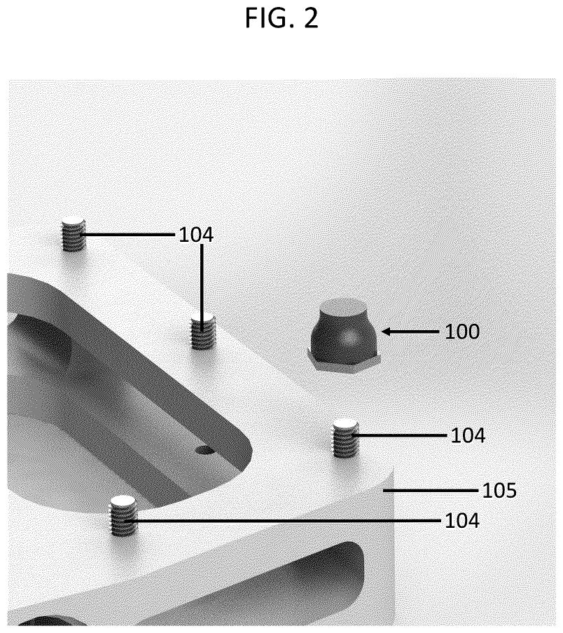

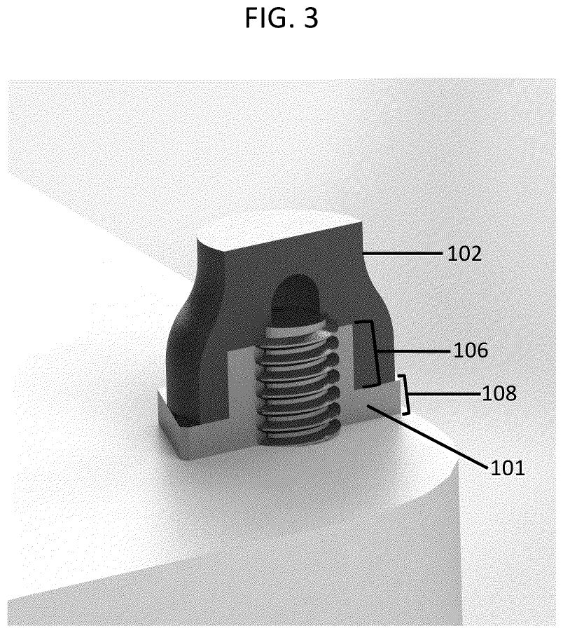

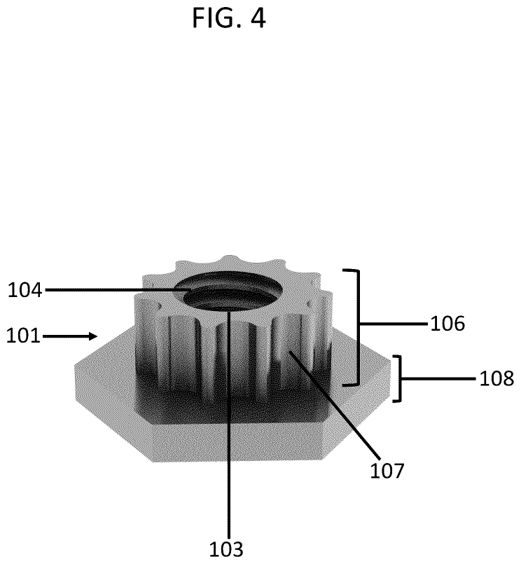

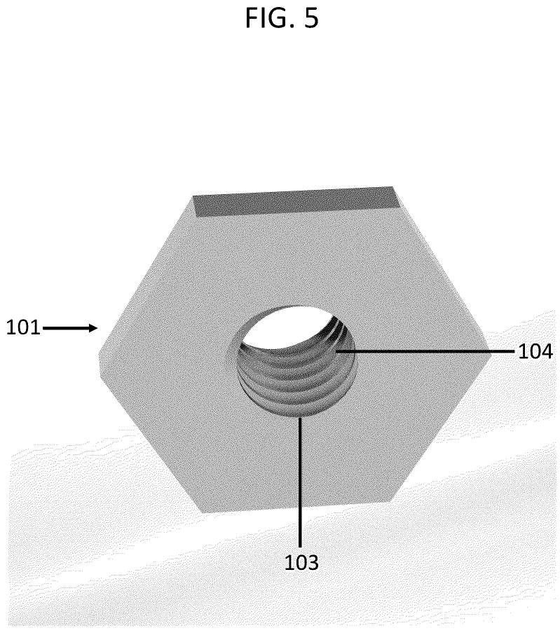

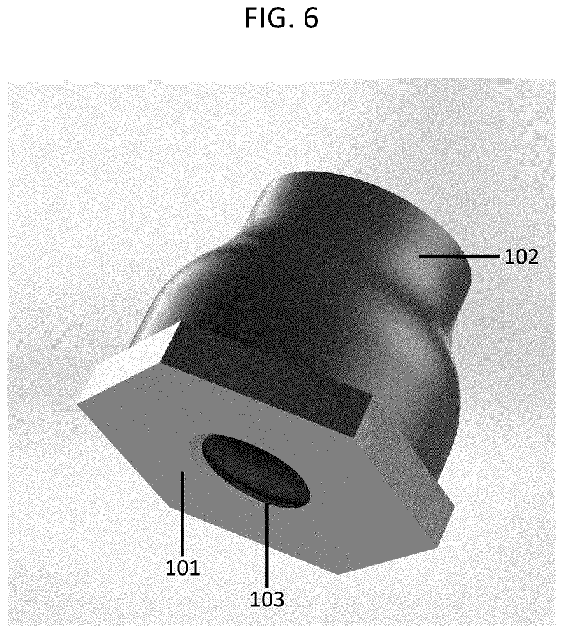

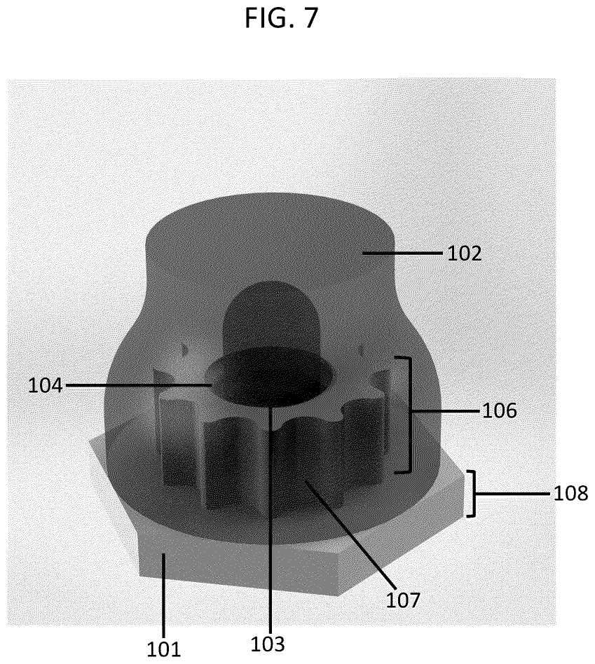

FIGS. 1-7 illustrate an example of a bike pedal stud 100 and components thereof comprising an insert component 101 and an insert cover 102. The insert component 101 comprises a centered, cylindrical through-hole 103 and the internal surface 104 of the insert component 101 defining the cylindrical through-hole 103 is threaded. The insert component 101 is threaded onto a threaded pin 104 mounted onto a bike pedal 105. A top portion 106 of the insert component 101 is covered by the insert cover 102. The insert cover 102 is molded onto the top portion 106 of the insert component 101. An outer surface 107 of the top portion 106 of the insert component 101 is undulating. A bottom portion 108 of the insert component 101 is exposed. The bottom portion 108 of the insert component 101 is hexagonal such that a wrench may be used to attach or detach the bike pedal stud 100 from the pin 104 of the bike pedal 105.

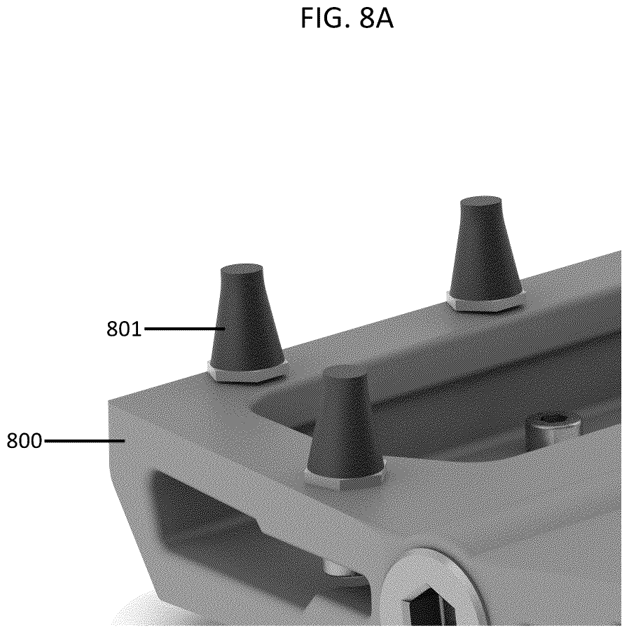

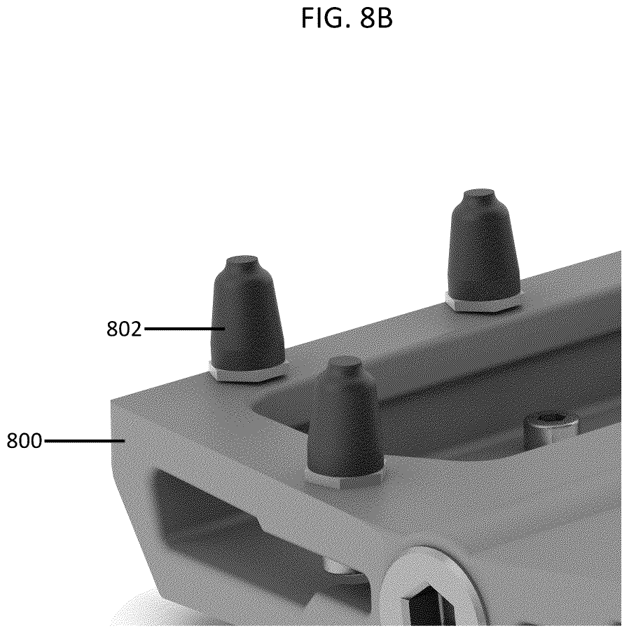

FIGS. 8A and 8B illustrate a bike pedal 800 with a plurality of the bike pedal studs 801 and 802, respectively.

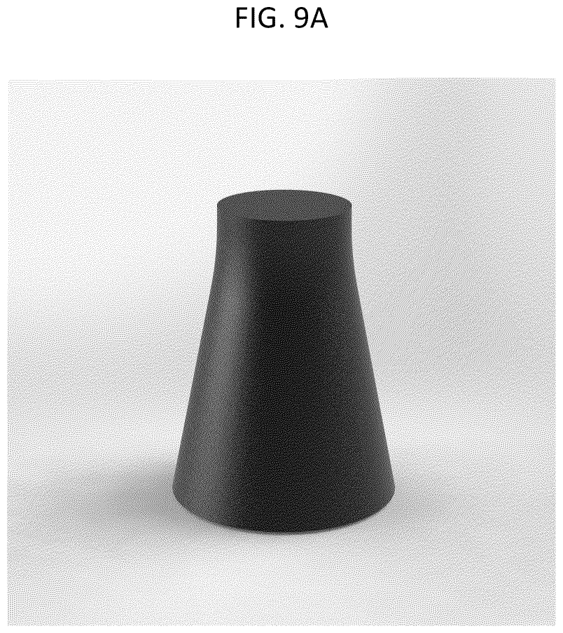

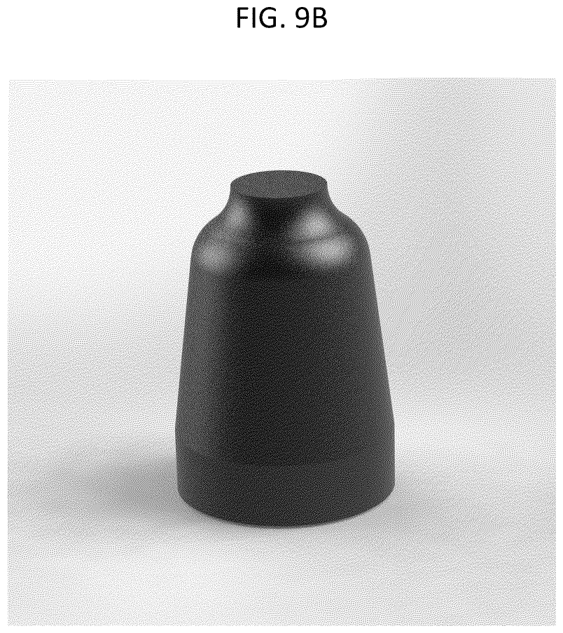

FIGS. 9A and 9B illustrate examples of different insert covers varying in height, radius or width, and sharpness of a top point (i.e., a top surface), dependent on the type of material from which the insert cover is fabricated.

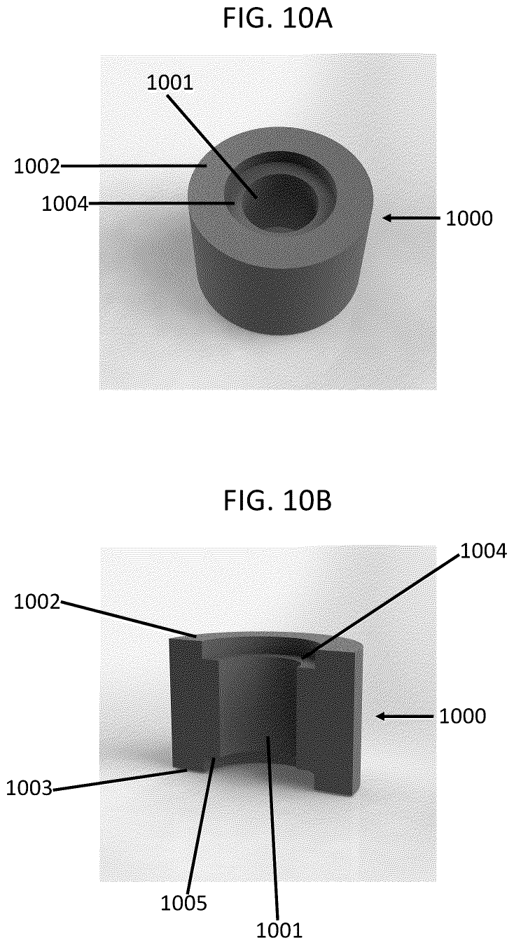

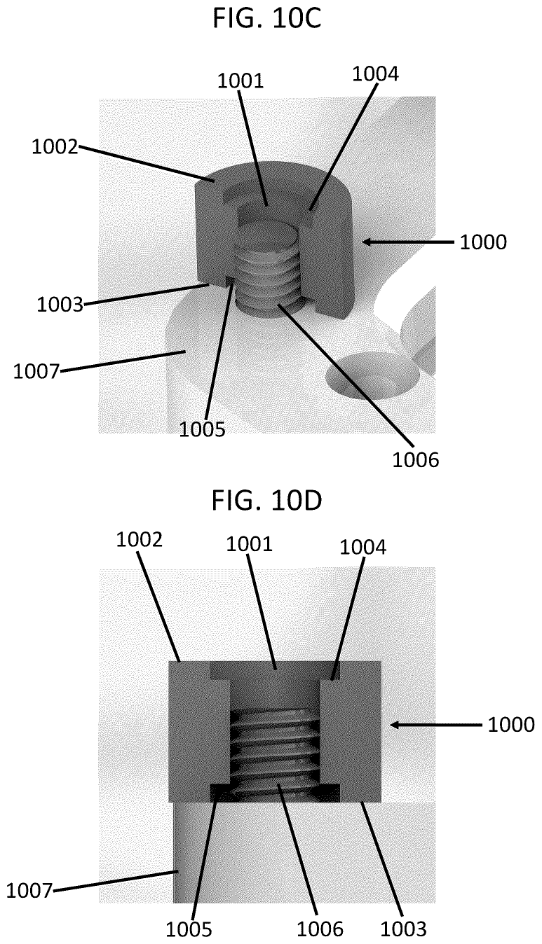

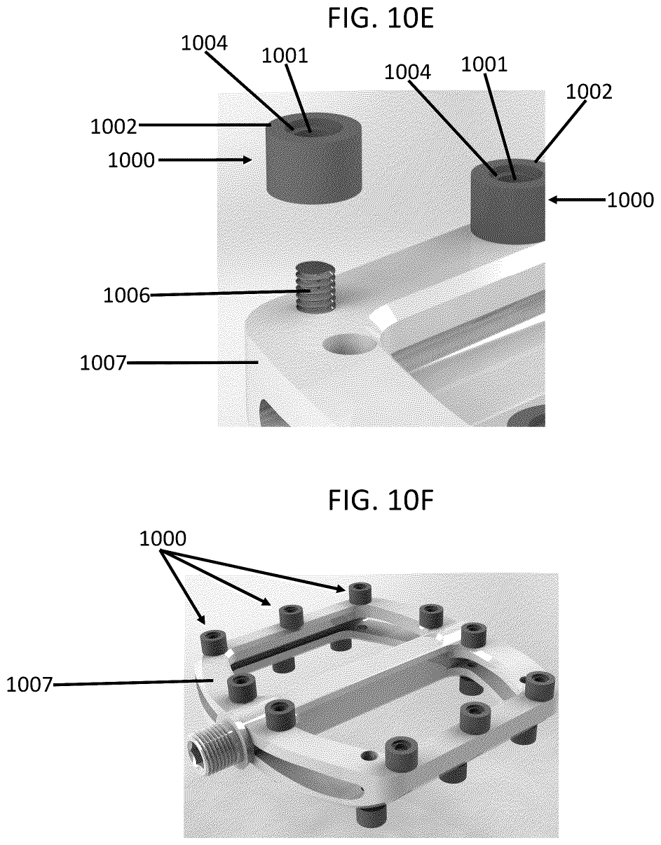

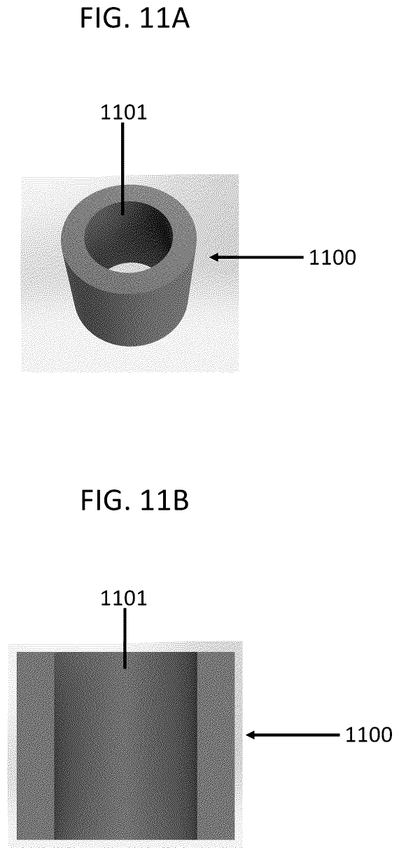

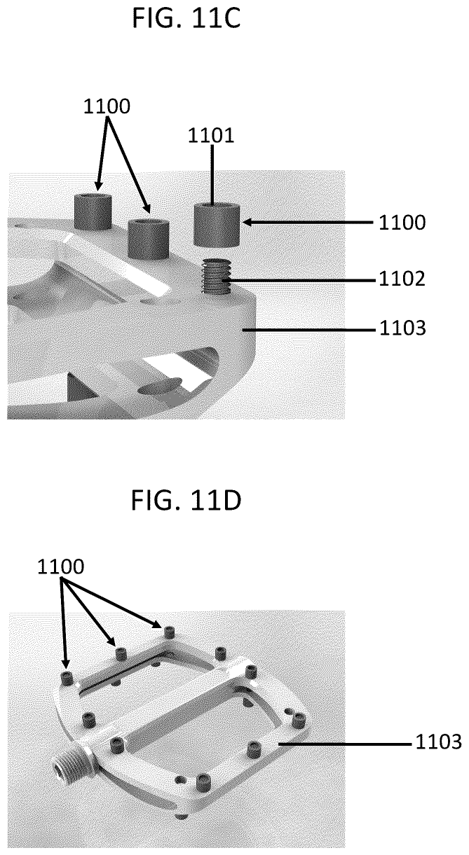

FIGS. 10A and 10B illustrate an example of a bike pedal stud comprising a cylindrical member 1000 including a cylindrical through-hole 1001 concentrically positioned within the cylindrical member 1000. A top surface 1002 and a bottom surface 1003 of the cylindrical member 1000 comprise a recessed annular feature 1004 and 1005. The recessed annular feature 1004 enhances friction between the cylindrical member 1000 and a sole of a shoe of a user, as described above. FIGS. 10B-10D, in particular, illustrate a cross-sectional view of the cylindrical member 1000. In FIGS. 10C-10F, each cylindrical member 1000 is manually pressed fit by the user onto a respective pin 1006 of a bike pedal 1007, covering the respective pin 1006 and thereby protecting legs of the user from potential laceration. A diameter of the cylindrical through-hole 1001 of each cylindrical member 1000 is smaller than a diameter of the respective pin 1006 covered, such that each cylindrical member 1000 remains in place due to friction fit between each cylindrical member 1000 and the respective pin 1006 covered. An outer diameter of cylindrical members 1000 are smaller in this case (in comparison to cylindrical members 1100 in FIGS. 11A-11D) and are therefore more suitable for shoes with harder soles.

FIGS. 11A and 11B illustrate an example of a bike pedal stud comprising a cylindrical member 1100 including a cylindrical through-hole 1101 concentrically positioned within the cylindrical member 1100. FIG. 11B, in particular, illustrates a cross-sectional view of the cylindrical member 1100. In FIGS. 11C and 11D, each cylindrical member 1100 is manually pressed fit by a user onto a respective pin 1102 of a bike pedal 1103, covering the respective pin 1102 and thereby protecting legs of the user from potential laceration. A diameter of the cylindrical through-hole 1101 of each cylindrical member 1100 is smaller than a diameter of the respective pin 1102 covered, such that each cylindrical member 1100 remains in place due to friction fit between each cylindrical member 1100 and the respective pin 1102 covered. An outer diameter of cylindrical members 1100 are smaller in this case (in comparison to cylindrical members 1000 in FIGS. 10A-10F) and are therefore more suitable for shoes with harder soles.

1. A bike pedal stud, comprising:
a member, wherein:
the member comprises a cylindrical hole centrally positioned within the member and extending at least partially through the member;
the member is press fit onto a pin of a bike pedal whereby the pin is inserted within the cylindrical hole of the member;
a diameter of the cylindrical hole is smaller than a diameter of the pin such that the member remains positioned on the pin due to a friction fit between the member and the pin; and
the member at least partially covers the pin when press fit onto the pin such that any contact between a skin of a user and the pin is prevented.

2. The bike pedal stud of claim 1, wherein:
the member comprises a cylindrical member; and
the cylindrical hole is concentrically positioned within the cylindrical member.

3. The bike pedal stud of claim 1, wherein the cylindrical hole comprises a through-hole extending through the member.

4. The bike pedal stud of claim 1, wherein at least one of a top surface of the member and a bottom surface of the member comprises a centrally positioned recessed feature.

5. The bike pedal stud of claim 4, wherein the top surface of the member and the bottom surface of the member comprise a centrally positioned recessed feature.

6. The bike pedal stud of claim 4, wherein the recessed feature comprises a recessed annular feature.

7. The bike pedal stud of claim 1, wherein:
the member comprises a cylindrical member;
the cylindrical hole is concentrically positioned within the cylindrical member;
the cylindrical hole comprises a through-hole extending through the cylindrical member; and
a top surface of the cylindrical member and a bottom surface of the cylindrical member each comprise a concentrically positioned recessed annular feature.

8. The bike pedal stud of claim 1, wherein the member is fabricated from a polymer.

9. A bike pedal, comprising:
a pedal;
a plurality of pins; and
a plurality of bike pedal studs, each bike pedal stud comprising a member, wherein:
the member comprises a cylindrical hole centrally positioned within the member and extending at least partially through the member;
the member is press fit onto a pin of the bike pedal whereby the pin is inserted within the cylindrical hole of the member;
a diameter of the cylindrical hole is smaller than a diameter of the pin such that the member remains positioned on the pin due to a friction fit between the member and the pin; and
the member at least partially covers the pin when press fit onto the pin such that any contact between a skin of a user and the pin is prevented.

10. The bike pedal of claim 9, wherein:
the member comprises a cylindrical member;
the cylindrical hole is concentrically positioned within the cylindrical member; and
the cylindrical hole comprises a through-hole extending through the cylindrical member.

11. The bike pedal of claim 10, wherein a top surface of the member and a bottom surface of the member comprise a centrally positioned recessed feature.

12. The bike pedal of claim 11, wherein the recessed feature comprises a recessed annular feature.

13. A method for providing grip between a shoe of a user riding a bike and a bike pedal of the bike during riding, comprising:
attaching a plurality of bike pedal studs to a plurality of corresponding pins mounted onto the bike pedal;
wherein:
each bike pedal stud comprises a member;
the member comprises a cylindrical hole centrally positioned within the member and extending at least partially through the member;
the member is press fit onto a pin of the bike pedal whereby the pin is inserted within the cylindrical hole of the member;
a diameter of the cylindrical hole is smaller than a diameter of the pin such that the member remains positioned on the pin due to a friction fit between the member and the pin; and
the member at least partially covers the pin when press fit onto the pin such that any contact between a skin of a user and the pin is prevented.

14. The method of claim 13, wherein:
the member comprises a cylindrical member; and
the cylindrical hole is concentrically positioned within the cylindrical member.

15. The method of claim 13, wherein the cylindrical hole comprises a through-hole extending through the member.

16. The method of claim 13, wherein at least one of a top surface of the member and a bottom surface of the member comprises a centrally positioned recessed feature.

17. The method of claim 16, wherein the top surface of the member and the bottom surface of the member comprise a centrally positioned recessed feature.

18. The method of claim 16, wherein the recessed feature comprises a recessed annular feature.

19. The method of claim 13, wherein:
the member comprises a cylindrical member;
the cylindrical hole is concentrically positioned within the cylindrical member;
the cylindrical hole comprises a through-hole extending through the cylindrical member; and
a top surface of the cylindrical member and a bottom surface of the cylindrical member each comprise a concentrically positioned recessed annular feature.

20. The method of claim 13, wherein the member is fabricated from a polymer.
